(19) United States
(12) Patent Application Publication
(10) Pub. No.: US 2007/0195855 A1
(43) Pub. Date: Aug. 23, 2007

(54) FILLING LEVEL SENSOR AND ASSOCIATED OPERATING METHOD AND MANUFACTURING PROCESS AND CORRESPONDING USAGE

(75) Inventor: Ullrich Hetzler, Dillenburg-Oberscheid (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: ISABELLENHUTTE HEUSLER GMBH & CO. KG, Dillenburg (DE)

(21) Appl. No.: 11/676,360

(22) Filed: Feb. 19, 2007

(30) Foreign Application Priority Data
Feb. 20, 2006 (DE) 10 2006 007 801.2

(51) Int. Cl. G01K 1/00

(52) U.S. Cl. 374/100

(57) ABSTRACT

The invention relates to a filling level sensor with several thermoelements for measuring a level of a liquid, especially for detecting the level of a fuel in a fuel tank of a motor vehicle, wherein a separate heating device for heating the thermoelements can be eliminated. Furthermore, the invention also relates to an associated operating method and manufacturing process.

### BACKGROUND OF THE INVENTION

This invention relates to a filling level sensor for measuring a level of a liquid, especially for detecting the level of a fuel in a fuel tank of a motor vehicle.

Moreover, the invention relates to an operating method and a manufacturing process for such a filling level sensor.

Furthermore, the invention also relates to the novel usage of a thermocolumn consisting of several thermoelements without an additional heating as a filling level sensor.

From various manufacturers thermoelement-based filling level sensors are known that can be used, e.g., to measure the fuel level in a fuel tank of a motor vehicle. These known thermoelement-based filling level sensors comprise a plurality of thermoelements that are connected electrically in series and form an elongated, strip-shaped thermocolumn, whereby the hot contact points are arranged in a line above each other on the one side of the thermocolumn whereas the cold contact points of the thermoelements are likewise arranged in a line on the opposite side of the thermocolumn. The individual thermoelements are applied here on a carrier material that can be, e.g., a plastic foil (e.g., Kapton). Furthermore, the known thermoelement-based filling level sensors comprise a heating conductor that extends adjacent to the line of hot contact points of the thermoelements and makes possible an electric heating of the hot contact points. When current is supplied to the heating conductor, the thermoelements warm up differently below and above the liquid level.

Thus, the heating by the heating conductor results for the thermoelements immersed in the liquid in only a relatively slight temperature difference between the hot and the cold contact points since the heat generated by the heating conductor is removed there to a very great extent via the liquid that is a good heat conductor.

In contrast thereto, in the case of the thermoelements located above the liquid level only a small part of the heat generated by the heating conductor is removed, which results in a correspondingly greater temperature difference between the hot and the cold contact points.

Therefore, the known thermoelement-based filling level sensors generate a minimal thermoelectric voltage in the completely immersed state, that is, with a full tank, whereas on the other hand the thermoelectric voltage generated with an empty tank is maximal. Therefore, the level can be calculated in a simple manner from the electric voltage generated by the filling level sensor.

The automatic compensation of fluctuations of the surrounding temperature is especially advantageous in these filling level sensors based on thermoelements since the individual thermoelements only measure the differential temperature between a cold and a warm contact point so that a change of the surrounding temperature affects the hot and the cold contact points in the same manner and therefore has no influence on the measuring technique.

On the other hand, these filling level sensors based on thermoelements have the disadvantage of a complex construction and the associated relatively high price.

The invention therefore has the task of appropriately improving the previously described, known filling level sensors based on thermoelements.

This task is solved by a filling level sensor and an operating method and a manufacturing process in accordance with the invention.

All references cited herein are incorporated herein by reference in their entireties.

### BRIEF SUMMARY OF THE INVENTION

The invention comprises the general technical teaching of not heating the individual thermoelements with a separate heating but rather with a self-heating by means of the thermoelements themselves so that a separate heating as in the case of the initially described, known filling level sensors based on thermoelements can be eliminated. The self-heating therefore consists for the filling level sensor in accordance with the invention of the thermoelements and operates in accordance with the known Peltier effect.

However, the invention also claims protection for the use of known filling level sensors based on thermoelements with a separate heating in as far as the heating remains unused and the heating of the thermoelements takes place in the manner in accordance with the invention.

The Peltier effect is used for the heating of the thermoelements within the scope of the invention, which effect produces or destroys heat by a thermoelement as a function of the direction and the height of the current flow in the contact points, which results in a corresponding temperature difference between the hot and the cold contact points and therewith in a corresponding thermoelectric voltage. After the current has been cut out the temperature difference built up during the current flow in accordance with the Peltier effect can be measured between the hot and the cold contact points of the thermoelements as a Seebeck voltage at the output. Here too, the temperature difference built up during the current flow and therewith the subsequently measurable voltage are a function of whether the particular thermoelement was immersed in the liquid or not, since in the case of the immersed thermoelements the liquid reduces the temperature difference relatively rapidly on account of the good thermal conduction. Therefore, in the case of the filling level sensor in accordance with the invention the level can also be calculated in a simple manner from the electrical voltage produced by the filling level sensor.

Therefore, in the case of the filling level sensor in accordance with the invention the buildup of a temperature gradient in accordance with the Peltier effect and the measuring of the temperature gradient in accordance with the Seebeck effect preferably take place alternately.

In a preferred exemplary embodiment of the invention the thermoelements are electrically connected in series behind each other and preferably form an elongated thermocolumn, whereby the thermocolumn is aligned at an obtuse angle and preferably at a right angle to the liquid level. The concept of an obtuse-angle alignment of the thermocolumn relative to the liquid level used within the framework of the invention comprises angles of more than 45°, 55°, 65°, 75° or 85° between the thermocolumn and the liquid level.

When the filling level sensor in accordance with the invention is used as a tank sensor for measuring the level in the fuel tank it should be taken into consideration that fuel tanks in passenger cars frequently have a fissured (craggy) inside contour. The thermocolumn is then preferably curved and follows the inside contour of the fuel tank.

On the other hand, the individual thermoelements are preferably aligned at a right angle or at least at an obtuse angle to the longitudinal axis of the thermocolumn, that is, parallel to or at least at an acute angle to the liquid level. The concept, used within the framework of the invention, of an acute-angle alignment of the thermoelements comprises here angles less than 45°, 35°, 25°, 15° or even less than 5°.

In a variant of the invention the filling level sensor comprises only a single elongated thermocolumn containing a plurality of thermoelements connected electrically behind each other in series.

In contrast to that, in another variant of the invention the filling level sensor comprises several, preferably two elongated thermocolumns, each with a plurality of thermoelements, which thermocolumns are preferably electrically connected behind each other and are arranged substantially parallel adjacent to each other.

In a parallel arrangement of two elongated thermocolumns the hot contact points of the thermoelements of the two thermocolumns preferably face one another, which makes the heating more effective. The hot contact points of the thermoelements are therefore located between the two thermocolumns in this arrangement.

However, it is alternatively also possible that the cold contact points of the two adjacently arranged thermocolumns face each other. In this alternative arrangement the hot contact points are therefore on the outside whereas the cold contact points are arranged between the two thermocolumns.

As was the case for the initially described, known filling level sensor based on thermoelements the individual thermoelements have two different conductor materials connected to one another at a contact point. The one conductor material can be, e.g., a copper-nickel alloy, whereby CuNi44 is especially suitable. On the other hand, the other conductor material can be copper, a copper-manganese-nickel alloy, in particular Manganin®, or a nickel-chromium alloy. However, the invention is not limited to the previously cited conductor materials as regards the conductor materials of the thermoelements but rather can be basically realized even with other conductor materials.

Another commonality with the initially described, known filling level sensor preferably consists in the fact that the two conductor materials are preferably applied onto a carrier material.

In a variant of the invention the two different conductor materials of the thermoelements are applied on the same side of a carrier material (e.g., a plastic foil).

In contrast to that, in another variant of the invention the two different conductor materials of the thermoelements are arranged on opposite sides of the carrier material, whereby the different conductor materials are electrically connected to one another at a contact point by a plated-through hole extending through the carrier material.

The carrier material for the different conductor materials of the thermoelements can be, e.g., a foil (e.g., of plastic, Kapton) but a thin-walled tube can also be used as carrier material for the different conductor materials of the thermoelements.

It should furthermore be mentioned that the invention comprises not only the previously described filling level sensor in accordance with the invention as a single component but also comprises a complete level measuring apparatus with such a filling level sensor in accordance with the invention.

The level measuring apparatus according to the invention preferably comprises a current source that is arranged on the filling level sensor and can control the filling level sensor with a current in order to produce a temperature difference between the hot and the cold contact points in the individual thermoelements in accordance with the previously described Peltier effect. The concept of a current source used in the framework of the invention is to be understood in a general manner here and is not limited to idealized current sources with an infinite internal resistance.

For example, the current source can comprise an impulse generator for supplying the filling level sensor with current and which controls the filling level sensor with current impulses.

The supplying of the filling level sensor with current preferably takes place with a given electrical energy feed in order to achieve a given heating. In an impulse control of the filling level sensor a regulation is preferably provided that regulates the electrical charge that flows at an impulse, which results in a given electrical energy feed at a constant control voltage.

However, it is also alternatively possible that the current source controls the filling level sensor with a continuous current in order to produce a temperature difference in the thermoelements in accordance with the Peltier effect.

Furthermore, the level measuring apparatus in accordance with the invention preferably comprises a voltage measuring apparatus that is connected to the filling level sensor and measures the electrical voltage produced by the filling level sensor in the currentless state in order that the level can be derived from it.

In addition, the level measuring apparatus in accordance with the invention preferably comprises an integrator connected to the voltage measuring apparatus that integrates the measured voltage singly or doubly over a certain time period, which minimizes the noise and eliminates an offset.

However, the control and evaluation of the filling level sensor can also take place in the level measuring apparatus in accordance with the invention by a traditional microcontroller that assumes the electrical control of the thermoelements during the heating up and also carries out the measuring of the voltage produced by the thermoelements.

In a preferred exemplary embodiment of the level measuring apparatus in accordance with the invention the filling level sensor is arranged in a fuel tank of a motor vehicle and measures the level of the fuel in the fuel tank.

However, the filling level sensor in accordance with the invention can also be used to measure the level of other operating liquids of a motor vehicle such as, e.g., the cooling liquid, motor oil or the brake fluid. The filling level sensor is then accordingly arranged in a cooling liquid container, a motor oil container or a brake liquid container.

In addition, the filling level sensor in accordance with the invention is also suitable in general for measuring the level of fluids, which do not necessarily have to be liquids. For example, the filling level sensor in accordance with the invention can also measure the level of granulates, powders, chips, bulk material, etc. Accordingly, the filling level sensor in accordance with the invention can be arranged in very different mobile or stationary containers such as, e.g., tanks, silos, bunkers, etc. The particular fluid should merely have a sufficient thermal conductivity that should be greater than that of air.

Furthermore, the invention also comprises an operating method for the previously described filling level sensor in accordance with the invention in which the individual thermoelements are not heated by a separate heating as is the case for the initially described known filling level sensors. Therefore, even traditional filling level sensors with a separate heating can also be used within the framework of the operating method in accordance with the invention, which heating is not necessary and therefore remains inactive.

At first the thermoelements are preferably supplied with current within the framework of the operating method in accordance with the invention in order to produce a temperature difference over the individual thermoelements and subsequently a measuring of the electrical voltage produced by the filling level sensor, wherein the measuring preferably takes place in the currentless state after the current has been supplied. In a further step the filling level is then determined from the voltage measured in this manner.

The supplying of the filling level sensor with current preferably takes place in the operating method in accordance with the invention with current impulses. However, the invention is not limited to an impulse control of the thermoelements but rather can also be basically realized with a continuous supply of current to the thermoelements.

Furthermore, the invention also comprises a manufacturing process for the previously described filling level sensor in accordance with the invention that is distinguished in that a separate heating is not additionally applied on the carrier material for the thermoelements.

The conductor materials of the thermoelements can be applied here onto the carrier material by different processes such as, e.g., sputtering, printing, by galvanic processes or by processes with etching technology. However, as regards the application of the different conductor materials of the thermoelements onto the carrier material the invention is not limited to the processes previously cited by way of example but rather can also be realized with other processes.

Finally, the invention also comprises the novel usage of several thermoelements connected in series behind each other without a separate heating for measuring a level of a liquid, in particular for measuring the level of a fluid in a fuel tank of a motor vehicle.

### BRIEF DESCRIPTION OF SEVERAL VIEWS OF THE DRAWINGS

Other advantageous further developments of the invention are characterized in the dependent claims or are explained in detail in the following together with a description of the preferred exemplary embodiments of the invention with reference made to the figures.

FIG. 1 shows a schematic view of a filling level sensor in accordance with the invention with a single thermal column,

FIG. 2 shows an alternative exemplary embodiment of a filling level sensor in accordance with the invention with two thermal columns,

FIG. 3 shows a schematic view of a fuel tank of a motor vehicle with a filling level sensor in accordance with FIG. 1 arranged in it,

FIG. 4 shows a schematic view of a single thermoelement of the filling level sensor in accordance with the invention according to FIGS. 1 to 3,

FIG. 5 shows a schematic cross-sectional view of a filling level sensor in accordance with the invention in which the different conductor materials of the thermoelement are arranged on the same side of a carrier material,

FIG. 6 shows a simplified cross-sectional view of an alternative exemplary embodiment of a filling level sensor in accordance with the invention in which the different conductor materials of the thermoelements are arranged on opposite sides of the carrier material,

FIG. 7 shows a schematic view of a section of a thermocolumn with conductor materials applied on it successively in time,

FIG. 8 shows a section of an alternative exemplary embodiment of a thermocolumn consisting of uniform base material with a second, low-ohmic, thermoelectrically different layer,

FIG. 9 shows a schematic view of a section of a thermocolumn in which the different conductor materials of the thermoelements are applied on opposite sides of a carrier layer,

FIG. 10 shows a cross-sectional view through the thermocolumn of FIG. 9 along sectional line A-A,

FIG. 11 shows a simplified block diagram of a level measuring apparatus in accordance with the invention,

FIG. 12 shows an extremely simplified block diagram of a level measuring apparatus in accordance with the invention with a microcontroller for controlling and evaluating the filling level sensor, and

FIGS. 13A-D show different courses of current and voltage on the filling level sensor in accordance with the invention.

### DETAILED DESCRIPTION OF PREFERRED EMBODIMENTS OF THE INVENTION

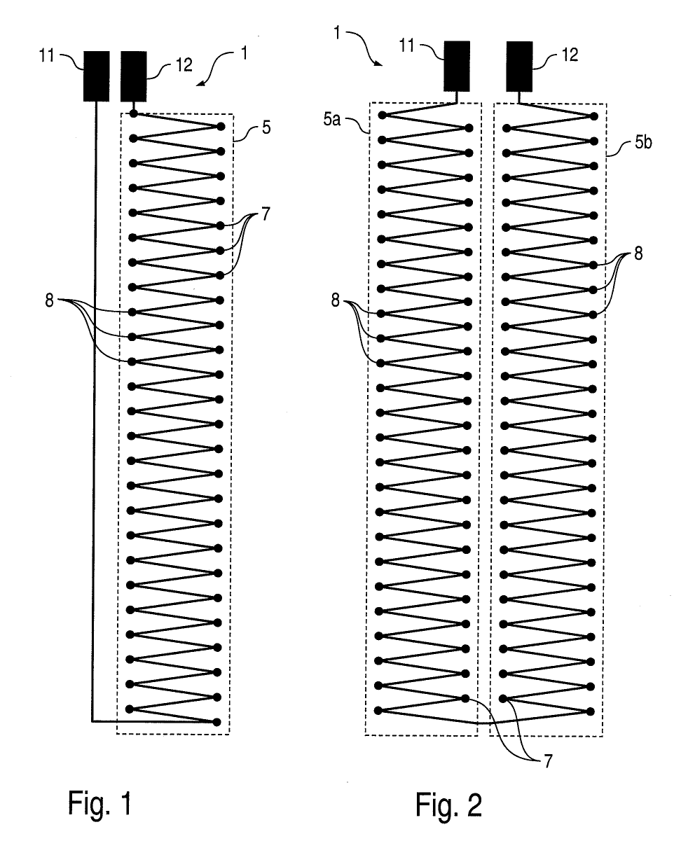

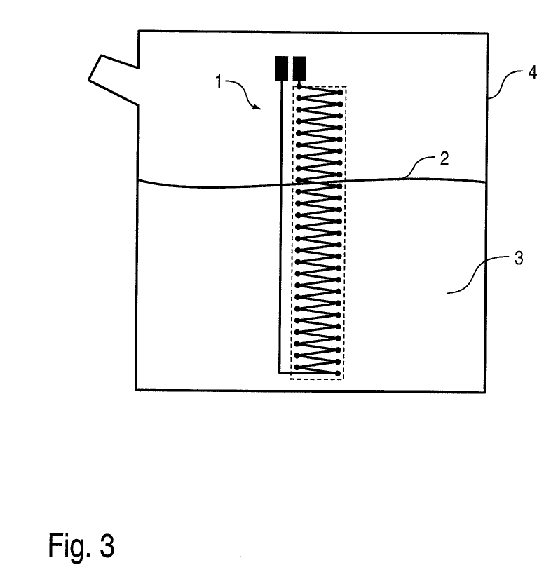

FIGS. 1 and 3 show a filling level sensor 1 in accordance with the invention that can be used, e.g., for measuring a level 2 of a fuel 3 in a fuel tank 4 of a motor vehicle, as is apparent from FIG. 3.

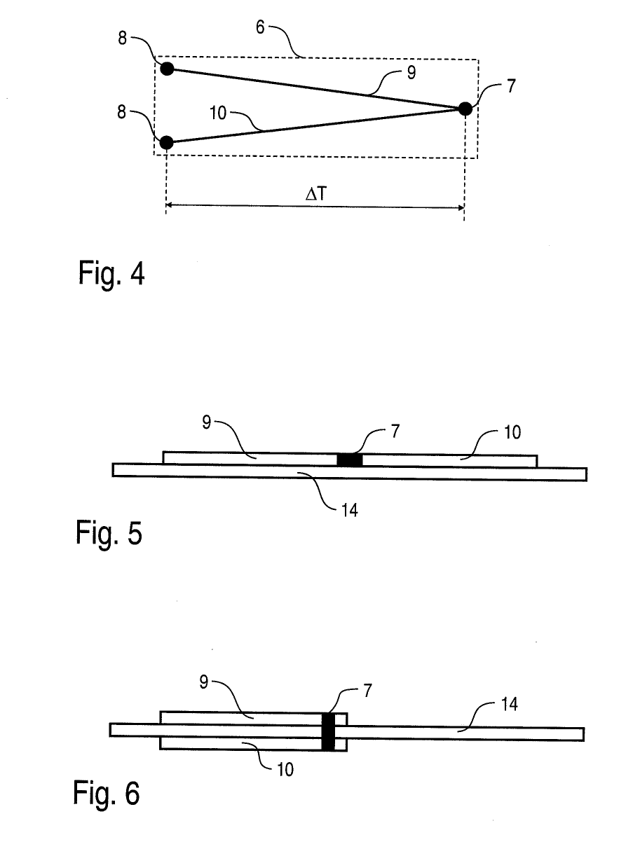

The filling level sensor 1 comprises a single thermocolumn 5 containing a plurality of thermoelements 6 electrically connected behind each other, whereby FIG. 4 shows the construction of the individual thermoelements 6. The individual thermoelements 6 comprise hot contact points 7 and cold contact points 8, whereby the hot contact points 7 are arranged on the one side and the cold contact points 8 on the other side in two parallel rows adjacent to one another.

Furthermore, the individual thermoelements 6 comprise two different conductor materials 9, 10, wherein the one conductor material in this exemplary embodiment is a copper-nickel alloy whereas the other conductor material is Manganin®.

The conductor materials 9, 10 of the individual thermoelements 6 are applied here onto a carrier material, as will be described in detail subsequently.

The thermocolumn 1 can be electrically contacted via two contact surfaces 11, 12, whereby the control of the filling level sensor 1 can take place, e.g., by a microcontroller 13, as is schematically shown in FIG. 12.

During a level measuring, the microcontroller 13 at first controls the filling level sensor 1 with current impulses so that the individual thermoelements 6 produce a temperature difference between the hot contact points 7 and the cold contact points 8 on account of the known Peltier effect.

After this supplying with current, the microcontroller 13 then measures the electrical voltage on the contact surfaces 11, 12, wherein this voltage is produced in accordance with the known Seebeck effect according to the temperature difference between the hot contact points 7 and the cold contact points 8.

In the thermoelements 6 immersed in the fuel 3 below the level 2 the temperature difference between the hot contact points 7 and the cold contact points 8 is largely compensated by the thermal conductivity of the fuel 3 so that the immersed thermoelements 6 produce only a low voltage.

In contrast thereto, in the thermoelements 6 that are not immersed in the fuel 3 above the level 2 in the fuel tank 4 the temperature difference between the hot contact points 7 and the cold contact points 8 is hardly reduced, since the surrounding air has only a relatively low thermal conductivity. Therefore, the non-immersed thermoelements 6 produce a relatively large thermovoltage that can be measured on the contact surfaces 11, 12 of the filling level sensor 1. The electrical voltage that can be measured on the contact surfaces 11, 12 therefore directly represents the level 2 of the fuel 3 in the fuel tank 4.

FIG. 2 shows an alternative exemplary embodiment of a filling level sensor 1 in accordance with the invention that largely coincides with the previously described exemplary embodiment so that reference is made to the previous description for FIG. 1 in order to avoid repetitions, whereby the same reference numerals are used for corresponding components.

This exemplary embodiment has the particularity that the level sensor 1 comprises two thermocolumns 5a, 5b arranged parallel and adjacent to one another. The cold contact points 8 are arranged here on the outside of the filling level sensor 1 whereas the hot contact points 7 of the two thermocolumns 5a, 5b face each other. However, the inverse spatial orientation of the hot and cold contact points 7, 8 is also possible.

FIG. 5 shows a simplified cross-sectional view through the filling level sensor 1 in accordance with FIG. 1. It is apparent from it that the conductor materials 9, 10 are arranged on the same side of a carrier material 14, whereby the carrier material 14 is a plastic foil in this exemplary embodiment.

FIG. 6 shows a simplified cross-sectional view through an alternative exemplary embodiment of the filling level sensor 1 in accordance with FIG. 1, in which the conductor materials 9, 10 of the thermoelements 6 are arranged on opposite sides of the carrier material 14. The electrical connection of the two conductor materials 9, 10 at the contact point 7 takes place here via a plated-through hole 15 extending through the carrier material 14.

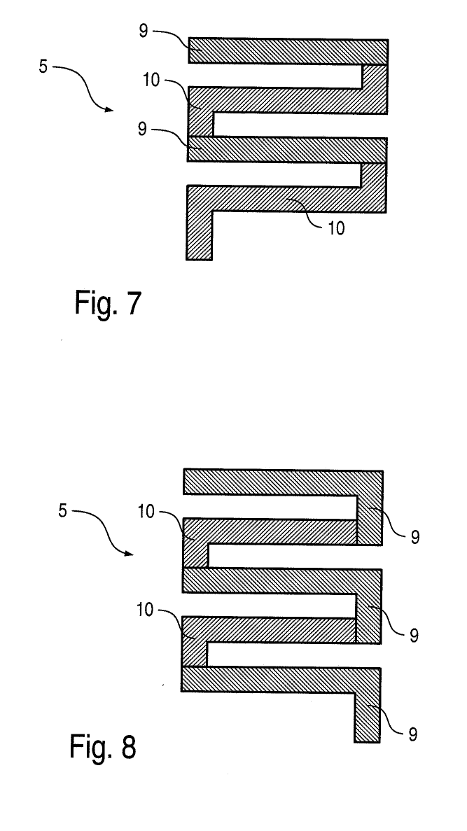

FIG. 7 shows a section through a thermocolumn 5 of a filling level sensor 1 in accordance with the invention, whereby the conductor materials 9, 10 were successively applied, which can take place, e.g., by sputtering, printing or by a galvanic manufacturing process.

FIG. 8 shows a simplified view of an alternative exemplary embodiment of a thermocolumn 5 in accordance with the invention, in which a conductor material 10 forms a uniform base material on which a conductor material 9 is applied as a second low-ohmic, thermoelectrically different layer. The application of the conductor material 9 can also take place here by sputtering, printing or by a galvanic process.

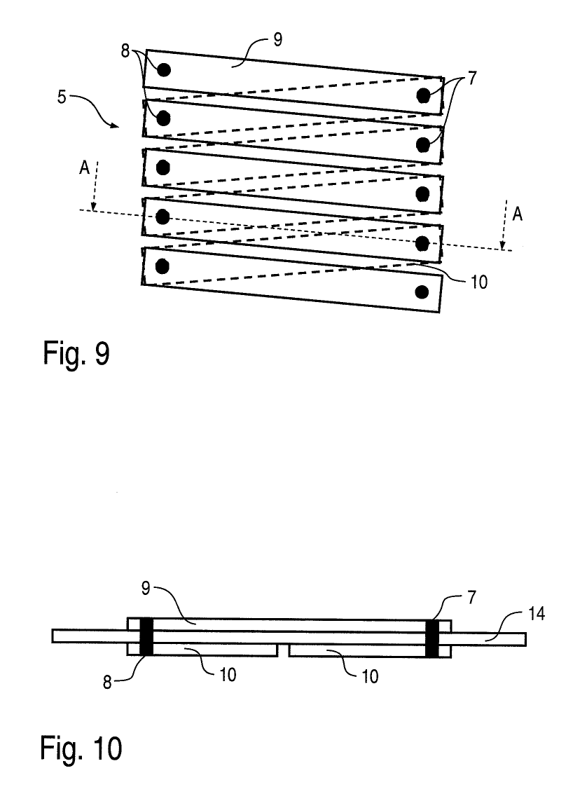

FIGS. 9 and 10 show an exemplary embodiment of a thermocolumn 5, in which conductor materials 9, 10 of the individual thermoelements 6 are applied on both sides of a carrier material 14, whereby plated-through holes are provided on hot contact points 7 and cold contact points 8 that extend through carrier material 14 and connect conductor materials 9, 10 to one another.

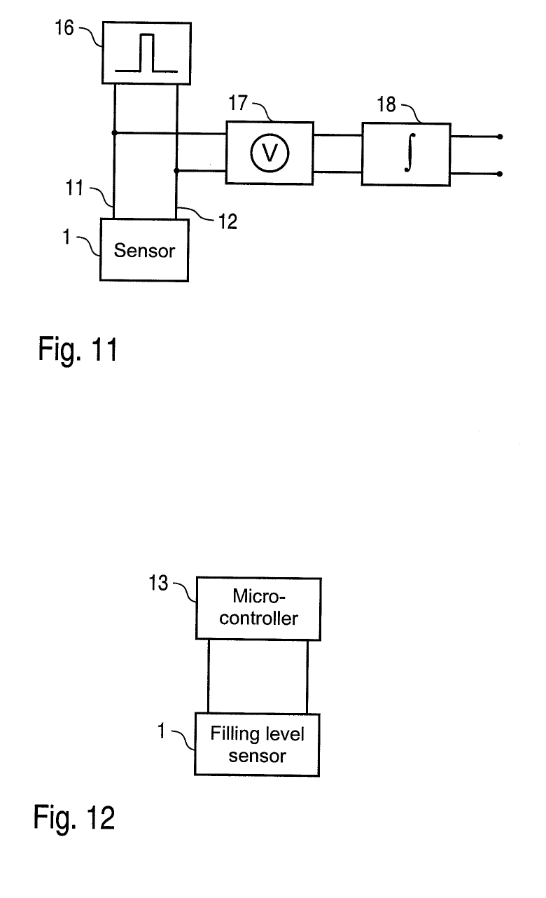

FIG. 11 shows a simplified block diagram of a level measuring apparatus in accordance with the invention with the previously described filling level sensor 1 in accordance with the invention.

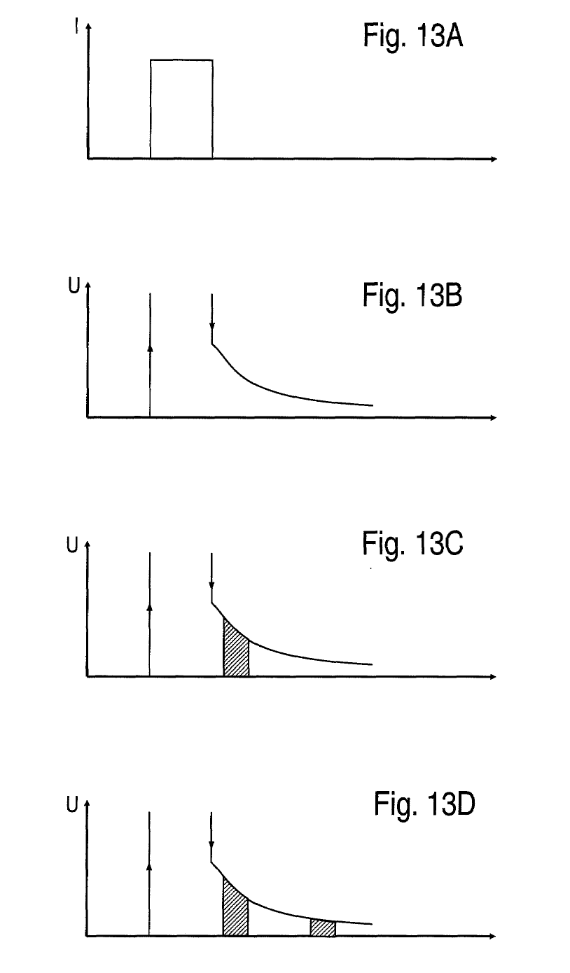

The filling level sensor 1 is controlled here by an impulse generator 16 with current impulses shown in FIG. 13A by way of example. The current impulses generated by impulse generator 16 result in the buildup of a temperature difference between the hot contact points 7 and the cold contact points 8 in accordance with the known Peltier effect. This produces a thermovoltage on the contact surfaces 11, 12 of the filling level sensor 1 that is measured by a voltage measuring apparatus 17. The course in time of the measured voltage is shown by way of example in FIGS. 13B-13D. After the end of a current impulse the voltage produced by the filling level sensor 1 gradually decreases since the temperature difference between the hot contact points 7 and the cold contact points 8 is reduced on account of the unavoidable thermal conduction. However, the measured voltage is a direct measure for the level 2 of the liquid to be measured.

In order to minimize the noise and to eliminate an offset the level measuring apparatus furthermore comprises an integrator 18 that integrates the measured voltage singly (see FIG. 13C) or doubly (see FIG. 13D).

The invention is not limited to the previously described preferred exemplary embodiments but rather a plurality of variants and modifications is possible that also make use of the inventive concept and therefore fall within the protective range.

What is claimed is:

1. A filling level sensor for measuring a filling level of a fluid, comprising a plurality of thermoelements, wherein no separate heating is provided for heating the thermoelements.

2. The filling level sensor according to claim 1, wherein the thermoelements are connected in series behind each other.

3. The filling level sensor according to claim 1, wherein the thermoelements form an elongated thermocolumn.

4. The filling level sensor according to claim 3, wherein the individual thermoelements are aligned substantially at a right angle to a longitudinal axis of the thermocolumn.

5. The filling level sensor according to claim 1, wherein the thermoelements form several elongated thermocolumns that are connected in series behind each other and are arranged substantially in parallel and adjacent to each other.

6. The filling level sensor according to claim 4, wherein the thermoelements have hot contact points and cold contact points, the hot contact points are arranged in a first line, the cold contact points are arranged in a second line, and the first line and the second line are on opposite sides of the thermocolumn.

7. The filling level sensor according to claim 6, wherein in the adjacent thermocolumns the hot contact points face each other.

8. The filling level sensor according to claim 6, wherein in the adjacent thermocolumns the cold contact points face each other.

9. The filling level sensor according to claim 1, wherein each of the thermoelements comprises a first conductor material and a second conductor material that are connected to each other at a contact point.

10. The filling level sensor according to claim 9, wherein the first and second conductor materials are arranged on a same side of a carrier material.

11. The filling level sensor according to claim 9, wherein the first and second conductor materials are arranged on opposite sides of a carrier material and are connected to one another at the contact point by a plated-through hole.

12. The filling level sensor according to claim 9, wherein the first conductor material is a copper-nickel alloy.

13. The filling level sensor according to claim 9, wherein the second conductor material is selected from the group consisting of copper, a copper-manganese-nickel alloy and a nickel-chromium alloy.

14. The filling level sensor according to claim 6, wherein the thermoelements are adapted to heat the hot contact points and cool the cold contact points as a function of an applied electrical current, and the thermoelements are adapted to produce a thermovoltage between the hot contact points and the cold contact points in a currentless state as a function of a temperature difference between the hot contact points and the cold contact points.

15. The filling level sensor according to claim 1, wherein the thermoelements are arranged on a foil as a carrier material.

16. The filling level sensor according to claim 1, wherein the thermoelements are arranged on a thin-walled tube as a carrier material.

17. A filling level measuring apparatus comprising a filling level sensor according to claim 1.

18. The filling level measuring apparatus according to claim 17, comprising:
(a) a current source connected to the filling level sensor and adapted to supply a current to the filling level sensor; and
(b) a voltage measuring apparatus connected to the filling level sensor and adapted to measure an electrical voltage produced by the filling level sensor in a currentless state.

19. The filling level measuring apparatus according to claim 18, wherein the current source comprises an impulse generator and is adapted to control the filling level sensor with current impulses.

20. The filling level measuring apparatus according to claim 18, comprising an integrator connected to the voltage measuring apparatus and adapted to perform a simple integration of the measured voltage.

21. The filling level measuring apparatus according to claim 18, comprising an integrator connected to the voltage measuring apparatus and adapted to perform a double integration of the measured voltage.

22. The filling level measuring apparatus according to claim 18, comprising a microcontroller connected to the filling level sensor and adapted for electrical controlling of the filling level sensor and for measuring the electrical voltage produced by the filling level sensor.

23. The filling level measuring apparatus according to claim 18, wherein the filling level sensor is arranged in a fuel tank of a motor vehicle and measures the filling level of a fuel in the fuel tank.

24. The filling level measuring apparatus according to claim 18, wherein the thermoelements form an elongated thermocolumn aligned at substantially a right angle to a fluid level to be measured.

25. The filling level measuring apparatus according to claim 18, wherein each thermoelement is aligned substantially parallel to a fluid level to be measured.

26. An operating process for a filling level sensor with several thermoelements, wherein the thermoelements are not heated by a separate heating.

27. The operating process according to claim 26, comprising the following steps:
(a) supplying the thermoelements with a current for producing a temperature difference over the individual thermoelements,
(b) measuring an electrical voltage produced by the filling level sensor, and
(c) determining a filling level from the measured voltage.

28. The operating process according to claim 26, wherein the filling level sensor is supplied with current impulses.

29. The operating process according to claim 27, wherein the measuring of the voltage takes place in a currentless state after the filling level sensor has been supplied with current.

30. The operating process according to claim 27, comprising a simple integration of the measured voltage.

31. The operating process according to claim 27, comprising a double integration of the measured voltage.

32. The operating process according to claim 26, wherein the filling level sensor is controlled and measured by a microcontroller.

33. A manufacturing process for a filling level sensor comprising the following steps:
(a) application of a plurality of thermoelements on a carrier material,
(b) electrical connection of the thermoelements to a series connection of each of the thermoelements,
wherein no separate heating device is applied on the carrier material.

34. The manufacturing process according to claim 33, wherein each thermoelement comprises a first conductor material and a second conductor material that are connected to one another at a contact point.

35. The manufacturing process according to claim 34, wherein the first and second conductor materials are applied on a same side of the carrier material.

36. The manufacturing process according to claim 34, wherein the first and second conductor materials are applied on opposite sides of the carrier material and a plated-through hole is produced in the carrier material at the contact point and extends through the carrier material.

37. The manufacturing process according to claim 34, wherein the first and second conductor materials are applied onto the carrier material by a method selected from the group consisting of sputtering, printing, a galvanic method and an etching method.

38. A method of measuring a filling level of a fluid, said method comprising:
providing a plurality of thermoelements connected in series behind each other; and
measuring the filling level of the fluid without a separate heating step.

39. The method according to claim 38, wherein the fluid is a fuel in a fuel tank of a motor vehicle.
